(19) United States
(12) Patent Application Publication
(10) Pub. No.: US 2006/0110253 A1
(43) Pub. Date: May 25, 2006

(54) Structure of turbine blower

(76) Inventor: Ging-Chung Chen, Damshui Taipei (TW)

Correspondence Address: BIRCH STEWART KOLASCH & BIRCH, PO BOX 747, FALLS CHURCH, VA, 22040-0747, US

(21) Appl. No.: 11/236,511

(22) Filed: Sep. 28, 2005

(30) Foreign Application Priority Data
Nov. 24, 2004 (TW) 093218855

(51) Int. Cl. B64C 11/00

(52) U.S. Cl. 416/182

(57) ABSTRACT

“An improved structure of turbine blower”, is mainly about installing several impellers in the form of a radial arrangement on a round bottom board. The characteristic of the design is that, the height of the impeller starts from the front of the impeller, near the center of the bottom board, lowers down to the corresponding low point in the middle section and elevates gradually to the front of the impeller. The top brim between the front and the rear of the impeller is in a curve shape. According to the above structure, when the air inlet or air outlet is obstructed, the power consumption will decrease automatically, so that the loading of the motor will be reduced.

### BACKGROUND OF THE INVENTION

I. Field of the Invention

This invention relates generally to an improved structure of turbine blowers, especially the kind of turbine structure that decreases the power consumption automatically when the air inlet or air outlet is obstructed, and could reduce the loading of the motor.

II. Description of the Prior Art

Heretofore, it is known that the structure of turbine blowers, as shown in FIG. 5, is to have several impellers b installed around the center of a round bottom board a. The impellers b stretch out from the proximity of the center of the round bottom board a to the outer brim of the round bottom board a in the form of a radial curve. The front b1 of the impeller b is located near the center of the round bottom board a. The height of the impeller b is the curve that starts from the front b1 to the lowest point of the rear b2 which gradually stretches out toward the outside horizontally. The turbine which is composed of a round bottom board a and the impellers b is placed in an air hood c, and could be propelled to rotate by a motor d. The air hood c comprises an air inlet c1, and an air outlet c2, and the air inlet c1 is placed above the center of the turbine (the center of the rotation) corresponding to the air outlet c2 which is installed on the outer brim of the turbine so that the air inhaled by air inlet c1 could be evacuated and exhaled by air outlet c2.

According to the structure described above, when the round bottom board a is driven by a motor and rotates at a high speed, a cylinder space would be formed between the fronts b1 of the impellers b and the center. This cylinder space is in a near vacuum state under negative pressure, therefore, it can inhale the air outside through the air inlet c1, push the air inhaled to the outer rim of rears b2 along the impellers b, and let the air pressure become positive again through the compression of rears b2 of the impellers b, so that the air can be expelled from air outlet c2.

However, the height of the rears b2 of impellers b of the known turbine blower is lower (i.e. the active surface is smaller), and might cause the insufficiency of positive pressure when exhausting air. Although the known design is unreasonable, it is still acceptable, and sometimes, can be used under certain circumstances, when there is no strict demand about the inhalation and the evacuation of the air, such as some simple common appliances like vacuum cleaner or blast furnace, but such design might not be applicable when the high air pressure is needed for the application. In addition, when one of the air inlet c1 or air outlet c2 of the known turbine is partially obstructed, since the difference between the positive and the negative pressure of the air formed in these two extremities is rather large, the motive power that propel the rotation of the turbine blower might increase and become several times higher, cause the increase of the loading for the motor, and might eventually burn out the motor.

### SUMMARY OF THE INVENTION

The primary object of the invention is to provide an improved structure for turbine blowers. With this design of impellers, we can control and maintain the existence of the positive and the negative air pressure produced by the blower, and thus lower the loading the motor.

In order to achieve the object set forth, the main characteristic of the improved structure of turbine blower is the height of the impellers which starts from the front of the impeller near the center of the bottom board and lowers down gradually to a corresponding low point in the middle section, and then elevates gradually from the corresponding low point till the rear of the impeller. The front to the rear of the impeller is in a curve shape.

Based on the structure described above, the turbine of the improved structure, which is composed of a round bottom board and the impellers, is installed inside an air hood. The air hood comprises an air inlet and an air outlet. The air inlet is installed above the center of the turbine (the pivot center), and the air outlet is installed on the outer rim of the turbine corresponding to the air inlet. Since the height of the rear of the impellers is higher, when the turbine rotates at high speed, the active surface, that the rear of the impeller formed by hitting the air, becomes larger and causes the increase of the pushing force against the air formed between the corresponding low point of the middle section and the rear of the impeller. The positive pressure in the expelling area (expelling quantity) in the rear of the impeller increases in order to have better air compression ratio (and larger expelling quantity). When the air inlet or the air outlet of the turbine is partially obstructed, the positive air pressure in the rear of impellers is guided to the rotation cylinder space in the front of the impellers to let the negative and the positive air pressure counterbalance each other. Till then, the power consumption of the turbine decreases instead of increasing, therefore, it can have the effect of decreasing the loading of motor.

### BRIEF DESCRIPTION OF THE DRAWINGS

The accomplishment of the above-mentioned object of the present invention will become apparent from the following description and its accompanying drawings which disclose an illustrative embodiment of the present invention, and are as follows:

FIG. 1 is a three-dimensional view of the present invention;

FIG. 2 is a side view of the present invention;

FIG. 3 is an application view of the present invention;

FIG. 4 is a cross-sectional view of the present invention;

FIG. 5 is a side view of the prior art.

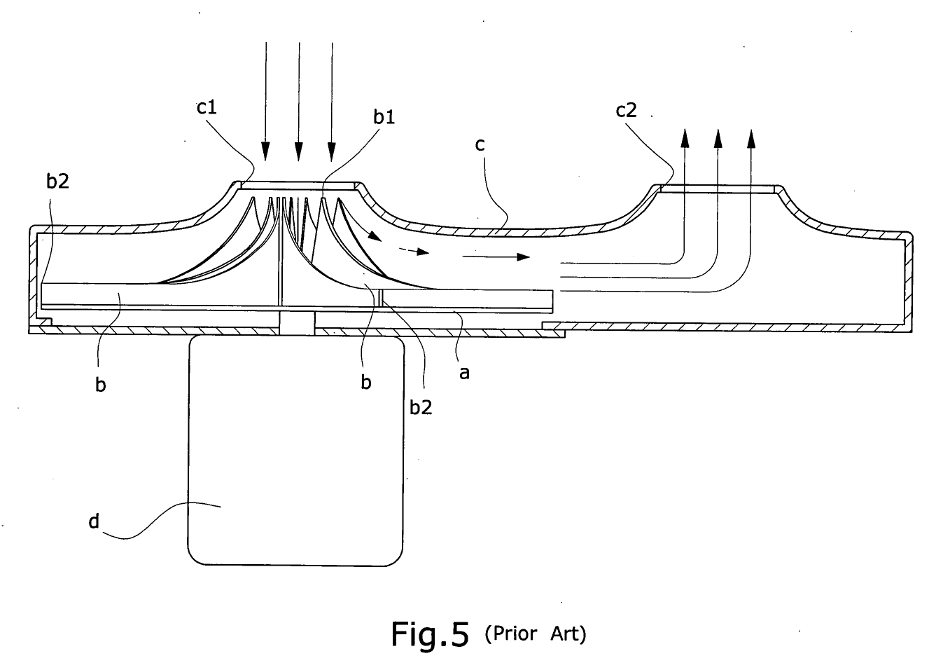

### DESCRIPTION OF THE PREFERRED EMBODIMENT

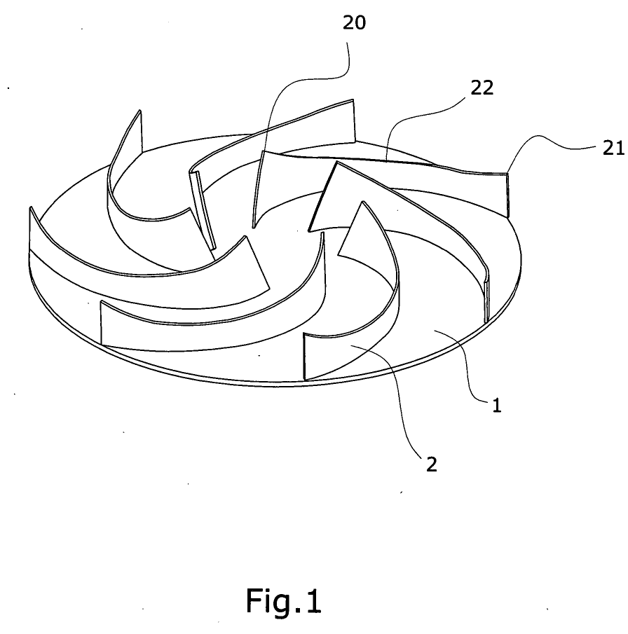

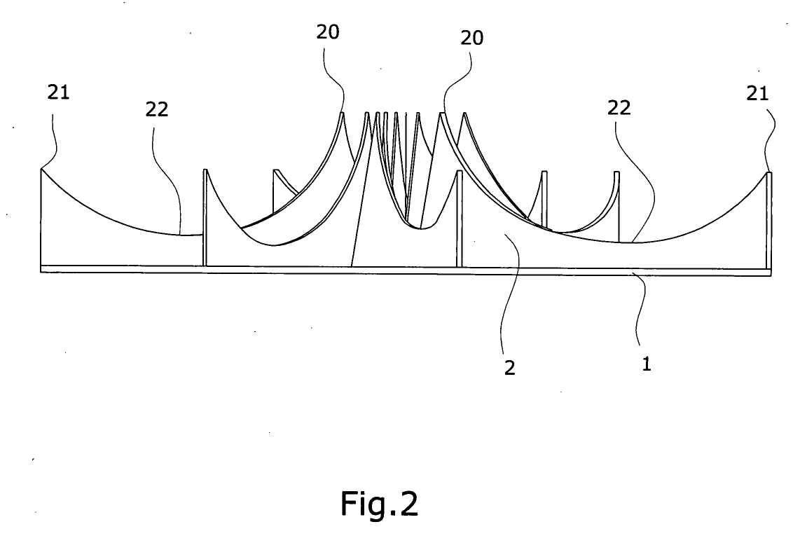

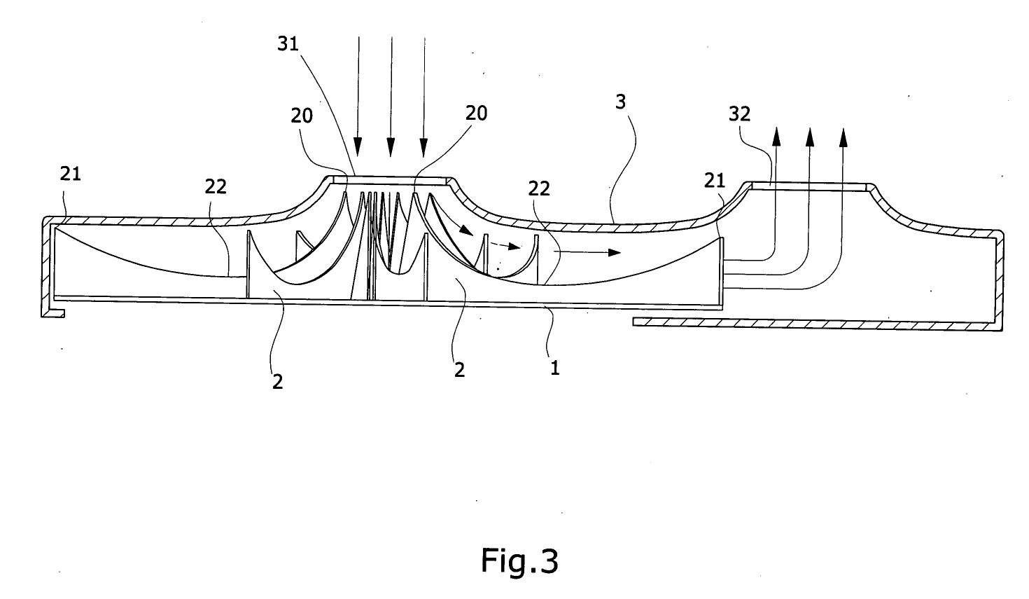

Referring to FIG. 1 to FIG. 3, the improved structure for turbine blower of the present invention has several impellers 2 installed on the surface of the round bottom board 1. The impellers 2 stretch out from near the center of the bottom board 1 in a radial curve shape to the outer brim of the bottom board 1. The round bottom board 1 and the impellers 2 are installed inside an air hood 3. The air hood 3 further comprises an air inlet 31 and an air outlet 32. The air inlet 31 is installed above the center of the turbine and the air outlet 32 is installed on the outer rim of the turbine corresponding to the air inlet 31. The function of each component is described as following:

The height of the impeller 2 is the curve that starts from the front 20 of the center of the impeller and lowers down gradually to a corresponding low point 22, and then elevates gradually from the corresponding low point 22 to the rear of the impeller 21. The top rim between the front 20 and the rear 21 of the impeller 2 is in a curve shape.

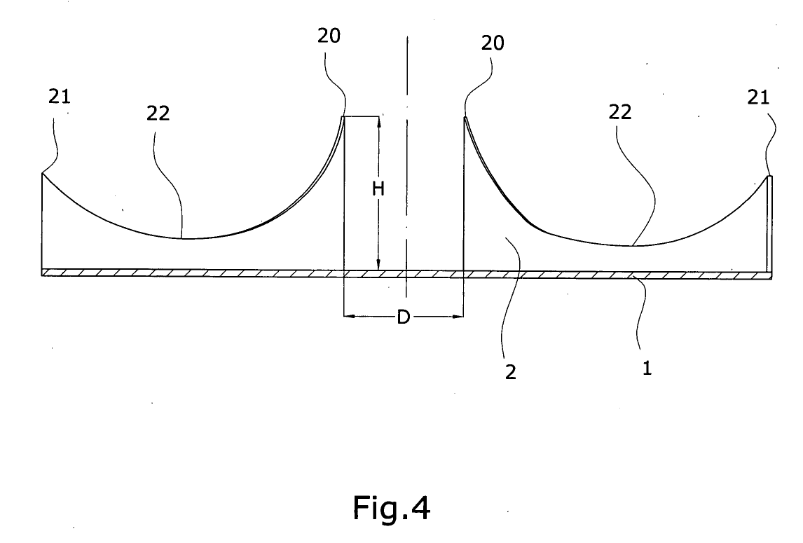

Referring to FIG. 4, the design principle of the height of the front 20 to the center of the bottom board 1 is to use the superficial measure of the circumference formed by the cylinder circle while rotation as a constant, for example: the height of the front 20 to the round bottom board 1 is 100 cm and the distance D (diameter) passing through the center of the bottom board 1 is 100 cm, so that the circumference area (π dh) of the rotation cylinder space formed during the rotation of the front 20 is 31416 cm². When the distance D (diameter) of the front 20 passing the center of the bottom board 1 is 150 cm, the height of the front 20 to the bottom board 1 should be 31416 cm²/(π*150 cm)=66.667 cm. The surface area of the cylinder space formed with the side height of the front 20 of the impeller 2 passing through any point in the center from the bottom board 1 is equal and is a constant, at the same time, a fixed negative air pressure attraction can be obtained with the rotation of the front 20.

When the front 20 (negative pressure) or the rear 21 (positive pressure) of the known turbine is obstructed, its loading becomes several times higher, such causes power loss or mechanism failure. However, the present invention can increase the height of the rear 21 with the modification of the shape of impeller 2, and strengthens the pressure (positive pressure) of the compressed air formed in the pressure part between the corresponding low point 22 and the rear 21. The air attraction (negative pressure) formed in the conducting part between the front 20 and the corresponding low point 22 maintains constant, so that the pressure and the attraction of the pressure part and the conducting part get to be counterbalanced in order to reduce the pressure difference between them, and to reduce gradually the power consumption of the turbine (according to experiment, when the present invention is driven by a 5 HP motor, under normal condition, the electrical current is 15 A: when the inlet or/and the outlet is (are) partially obstructed, the current on the multi-meter decreases rather than increases and lowers to 3 A to 5 A gradually) such also reduces the loading of motor.

While a preferred embodiment of the invention has been shown and described in detail, it will be understood and appreciated that numerous omissions, changes and additions may be made without departing from the spirit and scope of the invention.

What is claimed is:

1. A turbine blower comprising:
a round bottom board with several impellers. The impellers stretch out from near the center of the round bottom board in the form of a radial curve to the outer brim of the bottom board. The round bottom board and the impellers are inside an air hood. The air hood further comprises an air inlet and an air outlet. The air inlet is above the center of the turbine. The air outlet is installed on the outside of the turbine corresponding to the air inlet. The characteristic of the invention is that: the height of the impeller decreases from the front of the impeller to a center corresponding low point, then elevates from the center corresponding low to the rear of the impeller. The front of the impeller to the rear of the impeller is in curve shape.
